(19) United States
(12) Patent Application Publication
(10) Pub. No.: US 2011/0009040 A1
(43) Pub. Date: Jan. 13, 2011

(54) Knife Sharpening Tool

(76) Inventor: Shih-Piao Wu, Lu Kang Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/498,511

(22) Filed: Jul. 7, 2009

(51) Int. Cl. B24B 7/16; B21K 5/12; B26B 11/00

(52) U.S. Cl. 451/552; 76/82; 30/138

(57) ABSTRACT

A sharpening tool includes a handle, a first sharpening unit mounted on a first end of the handle, and a second sharpening unit mounted on a second end of the handle. The first sharpening unit includes a fixed blade mounted on the handle, a first threaded post rotatably mounted on the handle, a first slide having a first toothed portion meshing with the first threaded post, and a movable blade fixed on the first slide. The second sharpening unit includes a second threaded post rotatably mounted on the handle, a second slide having a second toothed portion meshing with the second threaded post, and a flat blade fixed on the second slide.

### BACKGROUND OF THE INVENTION

1. Field of the Invention

The present invention relates to a sharpening tool and, more particularly, to a knife sharpening tool to sharpen the blade of a knife.

2. Description of the Related Art

A conventional knife sharpening tool comprises a handle having a front end formed with a mounting seat, and a sharpening blade secured on a side of the mounting seat of the handle. Thus, when the knife sharpening tool is available for a knife, the sharpening blade is rested on a side of the knife. Then, the sharpening blade is pressed to move on the knife so as to grind and sharpen the knife. However, the user has to exert a larger force to press the sharpening blade onto the knife to grind and sharpen the knife exactly, thereby wasting the user's energy, and thereby causing inconvenience to the user. In addition, when the user's one hand holds the handle to move the sharpening blade, the sharpening blade easily slips from the knife due to an excessive force or a vibration, so that the knife is easily deflected to hurt the user's hand, thereby causing danger to the user. Further, the sharpening blade is exposed from the mounting seat of the handle when not in use, so that a user is easily scratched or hurt by the sharpening blade.

### BRIEF SUMMARY OF THE INVENTION

In accordance with the present invention, there is provided a sharpening tool, comprising a handle, a first sharpening unit mounted on a first end of the handle, and a second sharpening unit mounted on a second end of the handle. The first sharpening unit includes a fixed blade mounted on the first end of the handle, a first threaded post rotatably mounted on the first end of the handle, a first slide movably mounted on the first end of the handle and having a first toothed portion meshing with the first threaded post to move the first slide by rotation of the first threaded post relative to the handle, and a movable blade fixed on the first slide to move in concert with the first slide and movable relative to the fixed blade. The second sharpening unit includes a second threaded post rotatably mounted on the second end of the handle, a second slide movably mounted on the second end of the handle and having a second toothed portion meshing with the second threaded post to move the second slide by rotation of the second threaded post relative to the handle, and a flat blade fixed on the second slide to move in concert with the second slide and movable relative to the handle.

The primary objective of the present invention is to provide a sharpening tool, wherein the first sharpening unit is used to grind and sharpen double faces of the knife, and the second sharpening unit is used to grind and sharpen a single face of the knife, thereby enhancing the versatility of the sharpening tool.

Another objective of the present invention is to provide a sharpening tool, wherein the movable blade is moved relative to the fixed blade to adjust the relative position between the first notch of the fixed blade and the second notch of the movable blade so that the fixed blade and the movable blade of the first sharpening unit are used to grind and sharpen knives of different sizes and specifications.

A further objective of the present invention is to provide a sharpening tool, wherein the relative position between the fixed blade and the movable blade is adjusted to change the contact position between the knife and the fixed blade or the movable blade to prevent the fixed blade and the movable blade from being worn out or broken due to a frequent friction so as to enhance the lifetime of the first sharpening unit.

A further objective of the present invention is to provide a sharpening tool, wherein the flat blade of the second sharpening unit is retracted into the slideway of the handle and will not protrude outwardly from the breach of the handle when not in use, thereby preventing a user from being scratched or hurt by the flat blade of the second sharpening unit.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is perspective view of a sharpening tool in accordance with the preferred embodiment of the present invention.

FIG. 2 is an exploded perspective view of the sharpening tool as shown in FIG. 1.

FIG. 3 is a front broken view of the sharpening tool as shown in FIG. 1.

FIG. 4 is a schematic operational view of the sharpening tool as shown in FIG. 3.

FIG. 5 is a schematic operational view of the sharpening tool as shown in FIG. 1.

FIG. 6 is a schematic operational view of the sharpening tool as shown in FIG. 1.

### DETAILED DESCRIPTION OF THE INVENTION

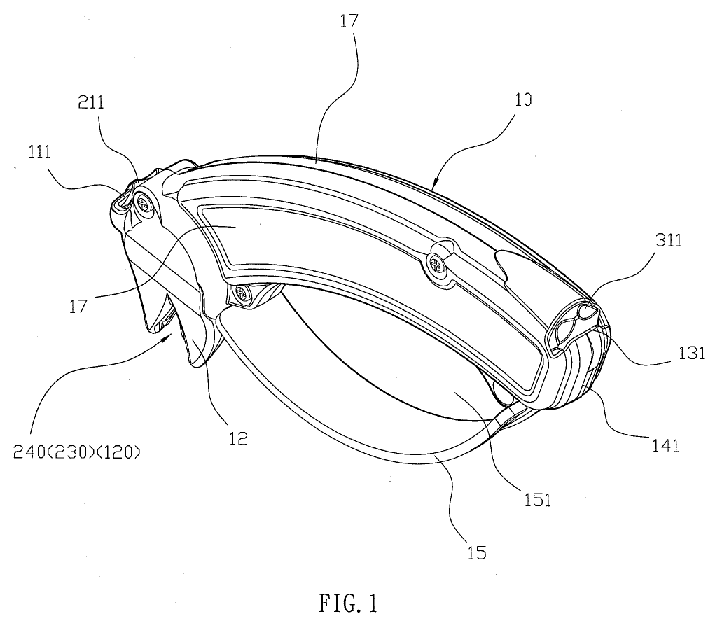

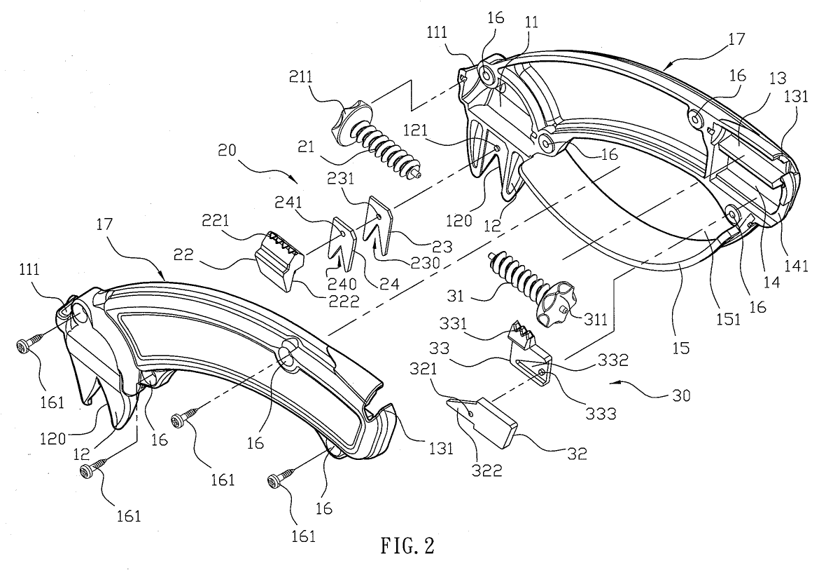

Referring to the drawings and initially to FIGS. 1-3, a sharpening tool in accordance with the preferred embodiment of the present invention comprises a handle 10, a first sharpening unit 20 mounted on a first end of the handle 10 and a second sharpening unit 30 mounted on a second end of the handle 10.

The first sharpening unit 20 includes a fixed blade 23 mounted on the first end of the handle 10, a first threaded post 21 rotatably mounted on the first end of the handle 10, a first slide 22 movably mounted on the first end of the handle 10 and having a first toothed portion 221 meshing with the first threaded post 21 to move the first slide 22 by rotation of the first threaded post 21 relative to the handle 10, and a movable blade 24 fixed on the first slide 22 to move in concert with the first slide 22 and movable relative to the fixed blade 23.

The first threaded post 21 of the first sharpening unit 20 has an end portion provided with a first rotation knob 211 to rotate the first threaded post 21 relative to the handle 10. The first rotation knob 211 of the first threaded post 21 protrudes outwardly from the first end of the handle 10. The first slide 22 of the first sharpening unit 20 has a side provided with a fixing face 222.

The fixed blade 23 of the first sharpening unit 20 is retracted into the first end of the handle 10. The fixed blade 23 of the first sharpening unit 20 has a first notch 230. The fixed blade 23 of the first sharpening unit 20 has a fixing hole 231 to fix the fixed blade 23 of the first sharpening unit 20 to the first end of the handle 10.

The movable blade 24 of the first sharpening unit 20 is retracted into the first end of the handle 10. The movable blade 24 of the first sharpening unit 20 abuts the fixed blade 23 and has a second notch 240 aligning with and movable relative to the first notch 230 of the fixed blade 23. The movable blade 24 of the first sharpening unit 20 has a fixing hole 241 to fix the movable blade 24 of the first sharpening unit 20 to the fixing face 222 of the first slide 22.

The second sharpening unit 30 includes a second threaded post 31 rotatably mounted on the second end of the handle 10, a second slide 33 movably mounted on the second end of the handle 10 and having a second toothed portion 331 meshing with the second threaded post 31 to move the second slide 33 by rotation of the second threaded post 31 relative to the handle 10, and a flat blade 32 fixed on the second slide 33 to move in concert with the second slide 33 and movable relative to the handle 10.

The second threaded post 31 of the second sharpening unit 30 has an end portion provided with a second rotation knob 311 to rotate the second threaded post 31 relative to the handle 10. The second rotation knob 311 of the second threaded post 31 protrudes outwardly from the second end of the handle 10. The second slide 33 of the second sharpening unit 30 has a slot 332 and a fixing stub 333.

The flat blade 32 of the second sharpening unit 30 has an end portion provided with a plug 322 inserted into the slot 332 of the second slide 33. The flat blade 32 of the second sharpening unit 30 has a fixing bore 321 fixed on the fixing stub 333 of the second slide 33 to secure the flat blade 32 to the second slide 33. The flat blade 32 of the second sharpening unit 30 is retracted into the second end of the handle 10 and is movable to protrude outwardly from the second end of the handle 10.

The handle 10 has an elongate arcuate shape and consists of two elongate arcuate casings 17 which are juxtaposed to each other. The casings 17 of the handle 10 are combined together by a plurality of locking screws 161. The handle 10 has a periphery provided with a plurality of locking holes 16 to lock the locking screws 161. The handle 10 has a side provided with a protective strap 15 to define a finger space 151 between the handle 10 and the protective strap 15.

The first end of the handle 10 has an inner portion provided with a chamber 11 to receive and allow movement of the first threaded post 21 of the first sharpening unit 20, and the first slide 22 of the first sharpening unit 20 is partially received in the chamber 11 of the handle 10. The first end of the handle 10 has a periphery provided with an opening 111 connected to the chamber 11, and the first rotation knob 211 of the first threaded post 21 protrudes outwardly from the opening 111 of the handle 10. The first end of the handle 10 has a side provided with a protruding housing 12 to receive the fixed blade 23 and the movable blade 24 of the first sharpening unit 20, and the first slide 22 of the first sharpening unit 20 is partially received in the housing 12 of the handle 10. The housing 12 of the handle 10 has a fixing boss 121 inserted into the fixing hole 231 of the fixed blade 23 to secure the fixed blade 23 to the housing 12 of the handle 10. The housing 12 of the handle 10 has a third notch 120 aligning with the first notch 230 of the fixed blade 23 and the second notch 240 of the movable blade 24 to expose the first notch 230 of the fixed blade 23 and the second notch 240 of the movable blade 24.

The second end of the handle 10 has an inner portion provided with a space 13 to receive and allow movement of the second threaded post 31 of the second sharpening unit 30 and a slideway 14 to receive and allow movement of the flat blade 32 of the second sharpening unit 30, and the second slide 33 of the second sharpening unit 30 is partially received in the space 13 of the handle 10 and partially received in the slideway 14 of the handle 10. The second end of the handle 10 has a periphery provided with an aperture 131 connected to the space 13, and the second rotation knob 311 of the second threaded post 31 protrudes outwardly from the aperture 131 of the handle 10. The second end of the handle 10 has a face provided with a breach 141 connected to the slideway 14, and the flat blade 32 of the second sharpening unit 30 is movable to retract into the slideway 14 of the handle 10 or to protrude outwardly from the breach 141 of the handle 10.

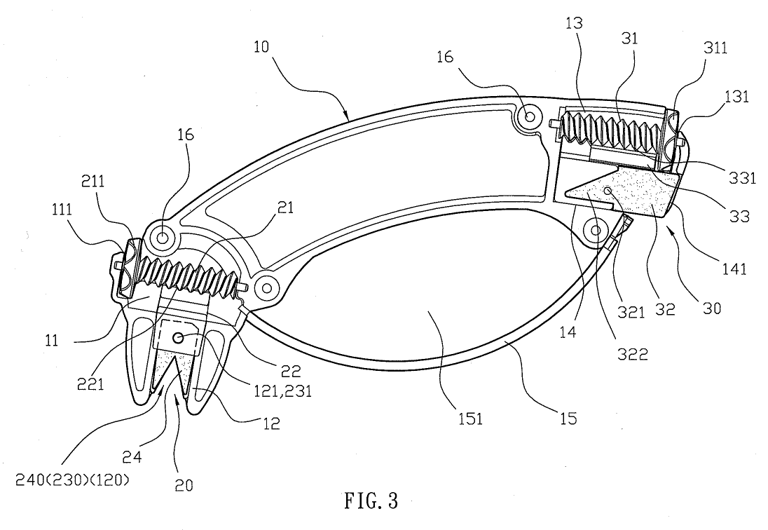

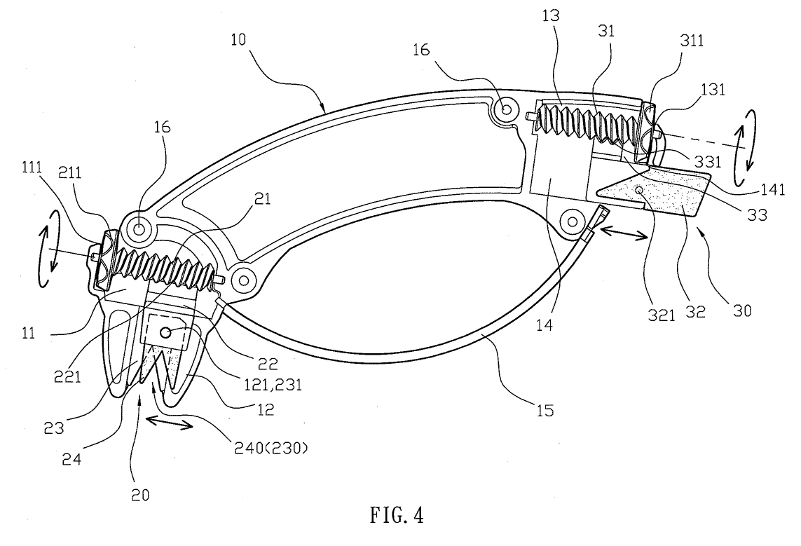

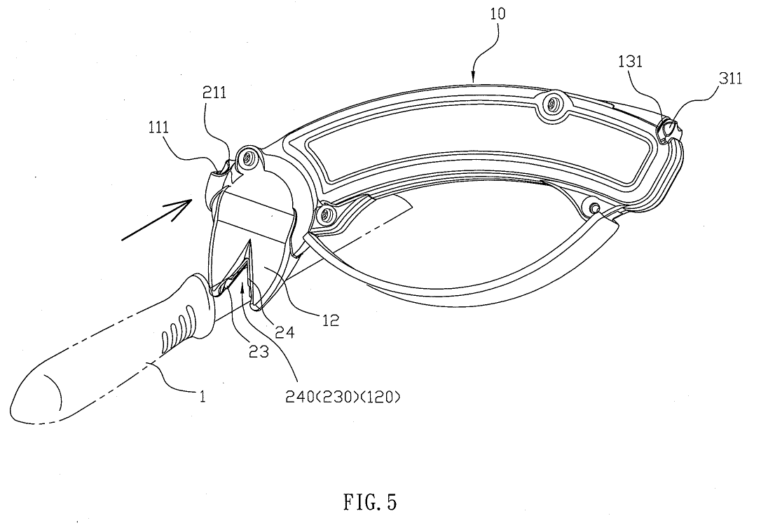

In operation, referring to FIGS. 4-6 with reference to FIGS. 1-3, the first notch 230 of the fixed blade 23 aligns with the second notch 240 of the movable blade 24 as shown in FIG. 3, so that the fixed blade 23 and the movable blade 24 of the first sharpening unit 20 are used to grind and sharpen two opposite faces of a knife 1 as shown in FIG. 5. When the first rotation knob 211 of the first threaded post 21 is rotated, the first threaded post 21 is rotated to move the first slide 22 which drives the movable blade 24 so that the movable blade 24 is moved relative to the fixed blade 23 to change and adjust the relative position and distance between the first notch 230 of the fixed blade 23 and the second notch 240 of the movable blade 24 as shown in FIG. 4. Thus, the fixed blade 23 and the movable blade 24 of the first sharpening unit 20 are used to grind and sharpen knives of different sizes.

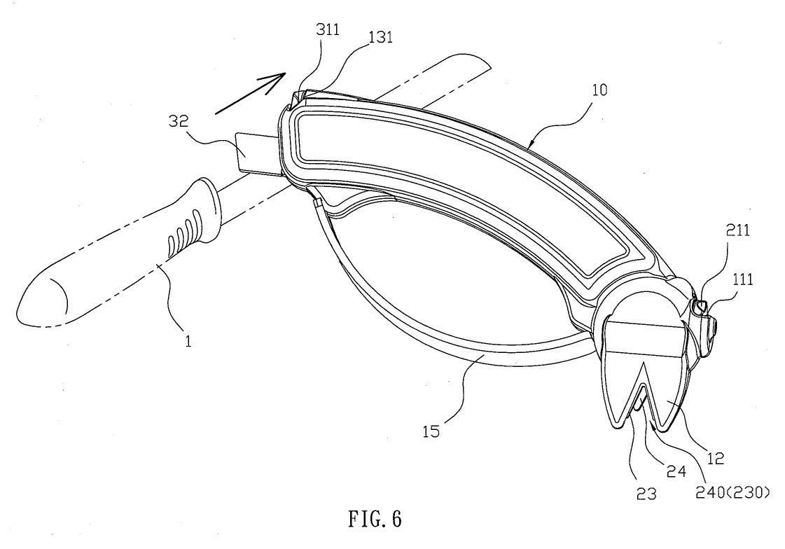

Alternatively, when the second rotation knob 311 of the second threaded post 31 is rotated, the second threaded post 31 is rotated to move the second slide 33 which drives the flat blade 32 so that the flat blade 32 is moved relative to the handle 10 to protrude outwardly from the breach 141 of the handle 10 as shown in FIG. 4. Thus, the flat blade 32 of the second sharpening unit 30 is used to grind and sharpen a single face of the knife 1 as shown in FIG. 6.

Accordingly, the first sharpening unit 20 is used to grind and sharpen double faces of the knife 1, and the second sharpening unit 30 is used to grind and sharpen a single face of the knife 1, thereby enhancing the versatility of the sharpening tool. In addition, the movable blade 24 is moved relative to the fixed blade 23 to adjust the relative position between the first notch 230 of the fixed blade 23 and the second notch 240 of the movable blade 24 so that the fixed blade 23 and the movable blade 24 of the first sharpening unit 20 are used to grind and sharpen knives of different sizes and specifications. Further, the relative position between the fixed blade 23 and the movable blade 24 is adjusted to change the contact position between the knife 1 and the fixed blade 23 or the movable blade 24 to prevent the fixed blade 23 and the movable blade 24 from being worn out or broken due to a frequent friction so as to enhance the lifetime of the first sharpening unit 20. Further, the flat blade 32 of the second sharpening unit 30 is retracted into the slideway 14 of the handle 10 and will not protrude outwardly from the breach 141 of the handle 10 when not in use, thereby preventing a user from being scratched or hurt by the flat blade 32 of the second sharpening unit 30.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A sharpening tool, comprising:
a handle;
a first sharpening unit mounted on a first end of the handle;
a second sharpening unit mounted on a second end of the handle.

2. The sharpening tool of claim 1, wherein
the first sharpening unit includes:
a fixed blade mounted on the first end of the handle;
a first threaded post rotatably mounted on the first end of the handle;
a first slide movably mounted on the first end of the handle and having a first toothed portion meshing with the first threaded post to move the first slide by rotation of the first threaded post relative to the handle;
a movable blade fixed on the first slide to move in concert with the first slide and movable relative to the fixed blade;
the second sharpening unit includes:
a second threaded post rotatably mounted on the second end of the handle;
a second slide movably mounted on the second end of the handle and having a second toothed portion meshing with the second threaded post to move the second slide by rotation of the second threaded post relative to the handle;
a flat blade fixed on the second slide to move in concert with the second slide and movable relative to the handle.

3. The sharpening tool of claim 2, wherein
the first threaded post of the first sharpening unit has an end portion provided with a first rotation knob to rotate the first threaded post relative to the handle;
the first rotation knob of the first threaded post protrudes outwardly from the first end of the handle;
the second threaded post of the second sharpening unit has an end portion provided with a second rotation knob to rotate the second threaded post relative to the handle;
the second rotation knob of the second threaded post protrudes outwardly from the second end of the handle.

4. The sharpening tool of claim 2, wherein
the fixed blade of the first sharpening unit has a first notch;
the movable blade of the first sharpening unit abuts the fixed blade and has a second notch aligning with and movable relative to the first notch of the fixed blade.

5. The sharpening tool of claim 4, wherein
the first end of the handle has a side provided with a protruding housing to receive the fixed blade and the movable blade of the first sharpening unit;
the housing of the handle has a third notch aligning with the first notch of the fixed blade and the second notch of the movable blade to expose the first notch of the fixed blade and the second notch of the movable blade.

6. The sharpening tool of claim 1, wherein
the handle has an elongate arcuate shape;
the handle has a side provided with a protective strap to define a finger space between the handle and the protective strap.

7. The sharpening tool of claim 5, wherein
the fixed blade of the first sharpening unit has a fixing hole to fix the fixed blade of the first sharpening unit to the first end of the handle;
the housing of the handle has a fixing boss inserted into the fixing hole of the fixed blade to secure the fixed blade to the housing of the handle.

8. The sharpening tool of claim 2, wherein
the first slide of the first sharpening unit has a side provided with a fixing face;
the movable blade of the first sharpening unit has a fixing hole to fix the movable blade of the first sharpening unit to the fixing face of the first slide.

9. The sharpening tool of claim 2, wherein
the second slide of the second sharpening unit has a slot and a fixing stub;
the flat blade of the second sharpening unit has an end portion provided with a plug inserted into the slot of the second slide;
the flat blade of the second sharpening unit has a fixing bore fixed on the fixing stub of the second slide to secure the flat blade to the second slide.

10. The sharpening tool of claim 3, wherein
the first end of the handle has an inner portion provided with a chamber to receive and allow movement of the first threaded post of the first sharpening unit;
the first end of the handle has a periphery provided with an opening connected to the chamber;
the first rotation knob of the first threaded post protrudes outwardly from the opening of the handle.

11. The sharpening tool of claim 2, wherein
the second end of the handle has an inner portion provided with a slideway to receive and allow movement of the flat blade of the second sharpening unit;
the second end of the handle has a face provided with a breach connected to the slideway;
the flat blade of the second sharpening unit is movable to retract into the slideway of the handle or to protrude outwardly from the breach of the handle.

12. The sharpening tool of claim 3, wherein
the second end of the handle has an inner portion provided with a space to receive and allow movement of the second threaded post of the second sharpening unit;
the second end of the handle has a periphery provided with an aperture connected to the space;
the second rotation knob of the second threaded post protrudes outwardly from the aperture of the handle.

13. The sharpening tool of claim 2, wherein
the handle consists of two elongate arcuate casings which are juxtaposed to each other.
the casings of the handle are combined together by a plurality of locking screws;
the handle has a periphery provided with a plurality of locking holes to lock the locking screws.

14. The sharpening tool of claim 2, wherein
the fixed blade of the first sharpening unit is retracted into the first end of the handle;
the movable blade of the first sharpening unit is retracted into the first end of the handle.

15. The sharpening tool of claim 2, wherein the flat blade of the second sharpening unit is retracted into the second end of the handle.

16. The sharpening tool of claim 2, wherein the flat blade of the second sharpening unit is movable to protrude outwardly from the second end of the handle.

17. The sharpening tool of claim 10, wherein the first slide of the first sharpening unit is partially received in the chamber of the handle.

18. The sharpening tool of claim 5, wherein the first slide of the first sharpening unit is partially received in the housing of the handle.

19. The sharpening tool of claim 12, wherein the second slide of the second sharpening unit is partially received in the space of the handle.

20. The sharpening tool of claim 11, wherein the second slide of the second sharpening unit is partially received in the slideway of the handle.
